(19) United States
(12) Patent Application Publication
(10) Pub. No.: US 2006/0193681 A1
(43) Pub. Date: Aug. 31, 2006

(54) Ball and socket assembly

(75) Inventors: Mike Holierhoek, Catharines (CA); Ryan Belleau, Port Colborne (CA); Ken Langendoen, Catharines (CA); Keith Sanderson, Tillsonburg (CA)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: TRW Automotive U.S. LLC

(21) Appl. No.: 11/068,598

(22) Filed: Feb. 28, 2005

(51) Int. Cl. F16C 11/00

(52) U.S. Cl. 403/122

(57) ABSTRACT

A ball and socket assembly may be used in an automotive suspension system. It may include a ball stud having a shaft portion extending from a ball portion, and a bearing having a wall portion defining an open end and an end portion defining a closed end, with the wall portion and the end portion further defining a cavity having the ball portion received therein, and with the open end of the wall portion including a radially outwardly extending seal flange. A shell has a sidewall portion including a generally cylindrical inner surface for receiving the bearing. The sidewall portion of the shell defines an open end face adjacent to the open end of the bearing, with the seal flange of the bearing extending radially outward of the cylindrical inner surface of the shell and substantially covering the open end face of the shell. Also, the assembly provides for securing the shell to the bearing. The assembly may also include a boot having a first open end and a second open end enclosing a portion of the bearing and the ball stud and defining a grease cavity therein, with the second open end including a flange portion disposed between the seal flange and the open end face of the sidewall, and with the first end of the boot sealingly engaging the shaft portion of the ball stud.

### BACKGROUND OF INVENTION

The present invention relates generally to ball and socket assemblies, particularly those used in automotive vehicle-suspension systems.

Automotive vehicle suspensions systems are well known and typically include one or more ball and socket assemblies. A typical ball and socket assembly includes a ball stud received in a bearing, which are held in place by mounting a shell around the bearing. For these typical ball and socket assemblies, the shell is secured around the bearing by rolling the open end of a side wall of the shell over an edge of the bearing. This requires a larger amount of time than is desired and is a relatively complex assembly step. Moreover, conventional ball and socket assemblies include a boot, which is typically held in place by wire springs or clamps at both ends. These springs or clamps increase the number of parts in the assembly, so it is desirable to minimize the number of springs and clamps needed in a ball and socket assembly.

Thus, it is desirable to provide an improved ball and socket assembly, in particular for an automotive vehicle suspension system, that may be assembled quickly and easily while still providing the functionality required of the ball and socket assembly.

### SUMMARY OF INVENTION

An embodiment of the present invention contemplates a ball and socket assembly, which may be used in an automotive suspension system. The assembly may include a ball stud having a shaft portion extending from a ball portion; and a bearing having a wall portion defining an open end and an end portion defining a closed end, with the wall portion and the end portion further defining a cavity having the ball portion received therein, and with the open end of the wall portion including a radially outwardly extending seal flange. A shell has a sidewall portion including a generally cylindrical inner surface for receiving the bearing, with the sidewall portion of the shell defining an open end face adjacent to the open end of the bearing, and with the seal flange of the bearing extending radially outward of the cylindrical inner surface of the shell and substantially covering the open end face of the shell. Retention means secures the shell to the bearing.

An embodiment of the present invention contemplates a ball and socket assembly including a ball stud having a shaft portion extending from a ball portion, and including a bearing having a wall portion defining an open end and an end portion defining a closed end, with the wall portion and the end portion further defining a cavity having the ball portion received therein. Also, a shell has a sidewall portion including a generally cylindrical inner surface for receiving the bearing, with a dimple in the sidewall portion of the shell extending into the wall portion of the bearing to thereby secure the shell to the bearing.

An embodiment of the present invention contemplates a ball and socket assembly including a ball stud having a shaft portion extending from a ball portion. The ball and socket assembly may also include a bearing formed from a first bearing piece, having a first attachment face, and a second bearing piece, having a second attachment face permanent affixed to the first attachment face, with the bearing having a wall portion defining an open end and an end portion defining a closed end, the wall portion and the end portion further defining a cavity having the ball portion received therein, and with the bearing having a radially outwardly extending retention flange; and a shell having a sidewall portion including a generally cylindrical inner surface for receiving the bearing, and with the sidewall portion in engagement with the retention flange. The attachment faces may be advantageously affixed by spin welding them together after assembly of the shell to the bearing.

An embodiment of the present invention contemplates a ball and socket assembly including a ball stud having a shaft portion extending from a ball portion, and a bearing having a first bearing piece forming a wall portion including a first open end, a second open end and a barb extending radially inwardly adjacent to the second open end, and a second bearing piece forming an end portion including a retention surface and a second barb extending radially outwardly and engaging with the barb extending from the first bearing piece to secure the second bearing piece to the first bearing piece, and with the first bearing piece and the second bearing piece defining a cavity having the ball portion received therein. The assembly may also include a shell having a sidewall including a generally cylindrical inner surface for receiving the first bearing piece and a retention open end face engaged with the retention surface of the second bearing piece.

An embodiment of the present invention contemplates a ball and socket assembly including a ball stud having a shaft portion extending from a ball portion, and a bearing having a wall portion defining an open end and an end portion defining a closed end, the wall portion and the end portion further defining a cavity having the ball portion received therein, and with the bearing including a barbed flange extending from the end portion. The assembly may also include a shell having a sidewall portion including a generally cylindrical inner surface for receiving the bearing and an engagement flange extending from the shell and in engagement with the barbed flange to thereby secure the shell to the bearing.

An embodiment of the present invention contemplates a ball and socket assembly including a ball stud having a shaft portion extending from a ball portion, and a bearing having a wall portion defining an open end and an end portion defining a closed end, with the wall portion and the end portion further defining a cavity having the ball portion received therein, and the wall portion including an engagement mechanism. The assembly may also include a shell having a sidewall portion including a generally cylindrical inner surface for receiving the bearing and a second engagement mechanism on the inner surface of the sidewall portion and in engagement with the engagement mechanism of the bearing to thereby secure the shell to the bearing, and with a one of the engagement mechanism and the second engagement mechanism being a plurality of teeth.

An advantage of an embodiment of the present invention is that an open end of the boot can be retained and seal between to the shell and bearing assembly without the need for a wire spring or clamp, while also allowing for quick and easy assembly.

Another advantage of an embodiment of the present invention is that the shell can be assembled to the bearing without requiring an operation that folds the open end of the shell over the bearing in order to retain the two together.

A further advantage of an embodiment of the present invention is that the assembly of the shell to the bearing is improved by assembling the shell to a two piece bearing, with the two bearing pieces quickly and easily affixed to each other after assembly.

### BRIEF DESCRIPTION OF DRAWINGS

FIG. 1 is a partially cross sectioned, perspective view of a ball and socket assembly in accordance with a first embodiment of the present invention.

FIG. 2 is a partially cross sectioned, elevation view, on an enlarged scale, of the ball and socket assembly of FIG. 1.

FIG. 3 is a partially cross sectioned, partially exploded, perspective view of a ball and socket assembly, but without a boot shown, according to a second embodiment of the present invention.

FIG. 4 is partially cross sectioned, partially exploded, perspective view of a ball and socket assembly, but without a boot shown, according to a third embodiment of the present invention.

FIG. 5 is a partially cross sectioned, elevation view of the ball and socket assembly of FIG. 4.

FIG. 6 is a partially cross sectioned, elevation view of a ball and socket assembly according to a fourth embodiment of the present invention.

FIG. 7 is a partially cross sectioned, elevation view of a ball and socket assembly according to a fifth embodiment of the present invention.

FIG. 8 is a partially cross sectioned, elevation view of a ball and socket assembly according to a sixth embodiment of the present invention.

FIG. 9 is a partially cross sectioned, elevation view of a ball and socket assembly according to a seventh embodiment of the present invention.

FIG. 10 is a partially cross sectioned, elevation view of a ball and socket assembly according to an eight embodiment of the present invention.

### DETAILED DESCRIPTION

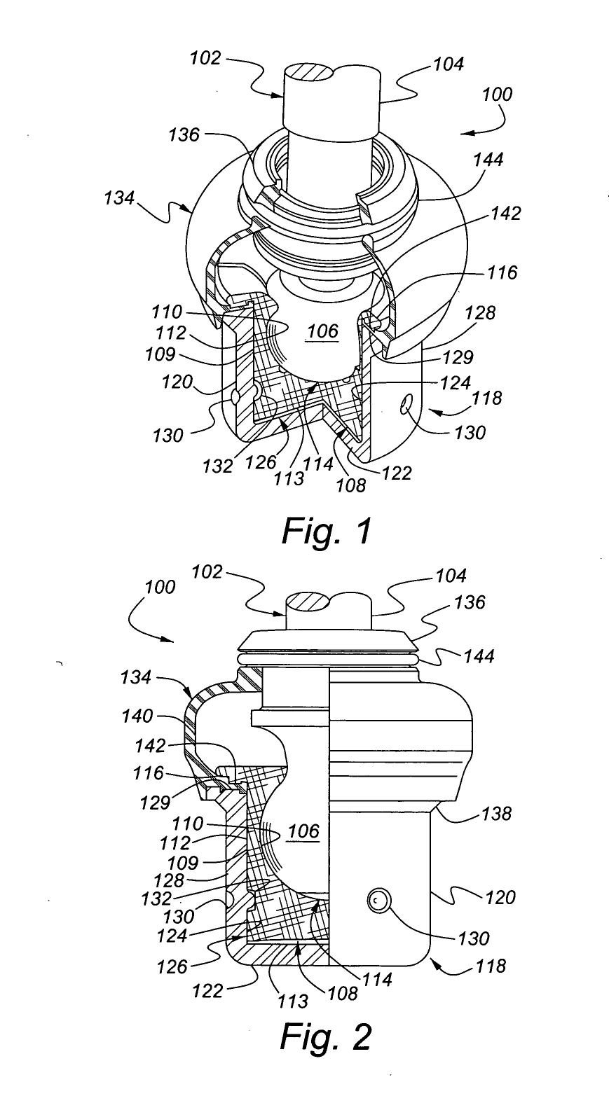

Referring now to FIGS. 1 and 2, a ball and socket assembly in accordance with a first embodiment of the present invention is indicated generally at 100. The assembly 100 includes a ball stud 102 having a shaft portion 104 extending from a ball portion 106. The ball stud 102 may be constructed of a metal, such as steel, aluminum, or the like.

A bearing 108 includes a side wall 109 with an inner surface 110 and an outer surface 112. The bearing 108 includes an enclosed end 113 defining a cavity 114 having the ball portion 106 received therein. A portion of the side wall 109 includes a radially outwardly extending seal flange 116. The bearing 108 may be constructed of a plastic material.

A shell 118 includes a sidewall 120 and an end wall 122. The sidewall 120 includes a generally cylindrical inner surface 124 defining a cavity 126 for receiving the bearing 108. The sidewall 120 includes an outer surface 128 and an open end face 129. The shell 118 may be constructed of a metal, such as steel, aluminum, or the like. The shell 118 is secured to the bearing 108 by pressing a conventional tool (not shown), such as a hardened steel tool or the like, into the outer surface 128 of the sidewall 120 to form dimples 130. Consequently, at the locations of the dimples 130, the inner surface 124 of the sidewall 120 extends radially inward. Preferably, at the locations of the dimples 130, the outer surface 112 of the bearing 108 includes a corresponding recess 132. The engagement of the dimples 130 in the recess 132 allows for quick and easy securing of the shell 118 to the bearing 108. Alternatively, the outer surface 112 of the bearing 108 may be formed without a recess. Then, when the tool forms the dimples 130, the dimples 130 will press into an deform the outer surface 112 of the bearing 108 in order to secure the shell 118 to the bearing 108.

A boot 134 having a first open end 136 and a second open end 138 encases a portion of the bearing 108 and the shell 118 and defines a grease cavity 140 therein. The second open end 138 includes a flange portion 142 disposed between the seal flange 116 of the bearing 108 and the open end face 129 of the shell 118. By sandwiching the flange portion 142 between the seal flange 116 and the end face 129, the second open end 138 may be advantageously retained and seal without the use of a wire spring or clamp. An inner surface of the first end 136 of the boot 134 seals against the shaft portion 104 of the ball stud 102. The first end 136 is secured to the shaft portion 104 by a wire spring or clamp 144 disposed in a groove formed in the outer surface of the boot 134. By sealing both ends 136, 138, grease is retained in the grease cavity 140 while contaminants are prevented from entering.

Preferably, the seal flange 116 of the bearing 108 extends radially outward of the cylindrical inner surface 124 of the sidewall 120 of the shell 118 and substantially covers the open end face 129 of the shell 118. While contrary to conventional ball and socket assemblies where the wall of the shell is rolled over the open end of the bearing in order to secure the two together, the seal flange 116 provides two significant advantages. First, the second open end 138 of the boot 134 can be retained and seal without the need for an extra clamp or spring. Second, for configurations where the shell 118 does not have a closed end, the seal flange 116, sometimes in combination with the flange portion 142 of the boot 134, sets a positive stop that prevents the shell 118 from sliding too far onto the bearing 108. Also, with the dimples 130 on the shell 118 engaging the bearing 108, the shell 118 is positively retained to the bearing 108.

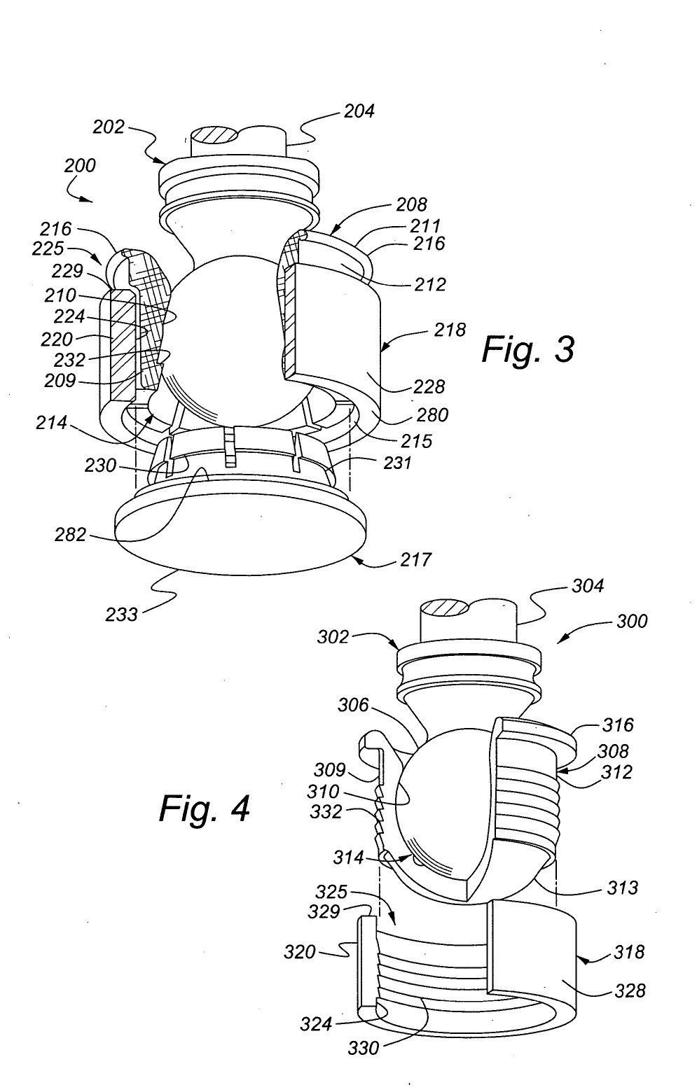

Referring now to FIG. 3, a ball and socket assembly in accordance with a second embodiment of the present invention is indicated generally at 200. The assembly 200 includes a ball stud 202 having a shaft portion 204 extending from a ball portion 206.

A bearing 208 has a first bearing piece 211 that includes a side wall 209 with an inner surface 210 and an outer surface 212 and a first open end 215. The side wall 209 includes a radially outwardly extending seal flange 216. The first bearing piece 211 is preferably constructed of a plastic material.

A shell 218 includes a sidewall 220 having a generally cylindrical inner surface 224 defining an opening 225 for receiving the first bearing piece 211. The sidewall 220 includes an outer surface 228, an open end face 229, and a second open end face 280. The first bearing piece 211 may be press-fit into the shell 218.

The bearing 108 also includes a second bearing piece 217 that includes a plurality of flanges 231 extending from a base portion 233, with the flanges 231 including barbs 230 that extend radially outwardly. The barbs 230 engage with a corresponding plurality of barbs 232 extending radially inwardly from the inner surface 210 of the first bearing piece 211 as the two bearing pieces 211, 217 are assembled. The two bearing pieces 211, 217, consequently, define a cavity 214, with an enclosed end, that receives the ball portion 106 therein. The cooperating barbs 230, 232 advantageously allow for quick and easy assembly of the shell 218 and the bearing pieces 211 and 217. Also, with the barbs 230, 232 engaged, a ring shaped retention surface 282 of the base 233 is sealingly held against the second open end face 280 of the shell 218, thus retaining the shell 218 on the bearing 208.

Preferably, the assembly 200 also includes a boot (not shown in FIG. 3), such as the boot 134 of FIG. 1. A flange portion (not shown in FIG. 3) of the boot may be disposed between the seal flange 216 and the open end face 229 of the shell 218, similar to the first embodiment. As with the first embodiment, the seal flange 216 preferably extends radially outward of the cylindrical inner surface 224 of the sidewall 220 of the shell 218 and substantially covers the open end face 229.

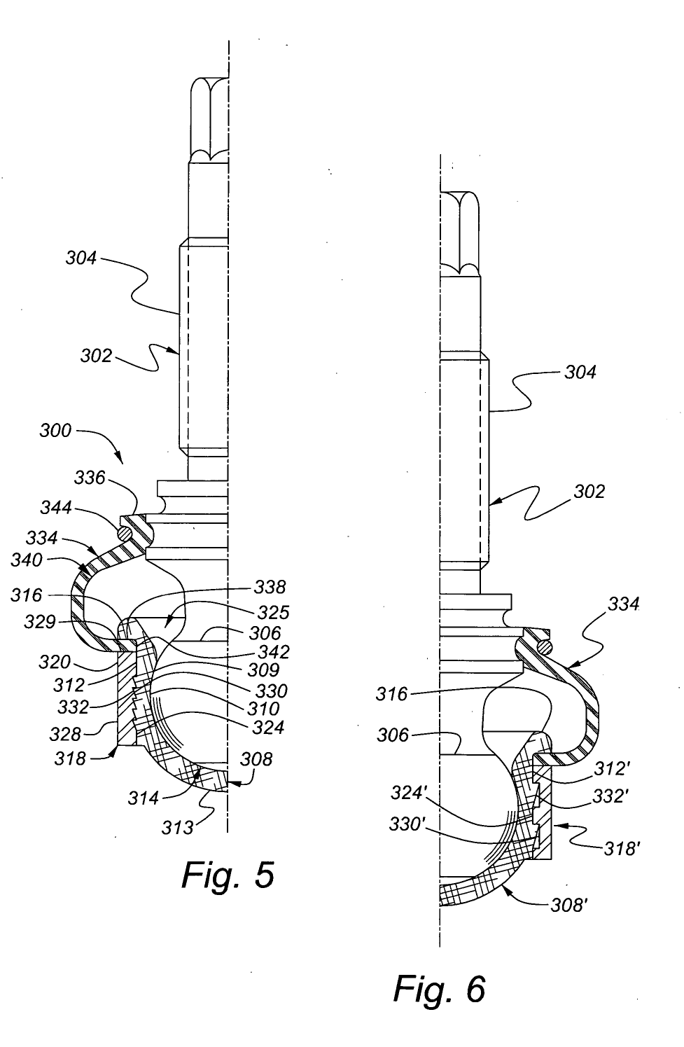

Referring now to FIGS. 4 and 5, a ball and socket assembly in accordance with a third embodiment of the present invention is indicated generally at 300. The assembly 300 includes a ball stud 302 having a shaft portion 304 extending from a ball portion 306.

A bearing 308 includes side wall 309 with an inner surface 310 and an outer surface 312. The bearing 308 includes an enclosed end 313 defining a cavity 314 within which is mounted the ball portion 306. A portion of the side wall 309 includes a radially outwardly extending seal flange 316. The outer surface 312 of the side wall 309 includes a set of radially outwardly extending teeth 332 extending generally around its circumference.

A shell 318 includes a sidewall 320 having a generally cylindrical inner surface 324 defining an opening 325 for receiving the bearing 308. The sidewall 320 includes an outer surface 328 and an open end face 329. Also, a set of teeth 330 extends from the inner surface 324 and are spaced and located to mate with the teeth 332 on the bearing 308. The shell 318, then, is secured to the bearing 308 by pressing the bearing 308 into the opening 325 of the shell 318 until the teeth 332 on the bearing 308 are fully engaged with the teeth 330 on the shell 318. The seal flange 316 of the bearing 308 preferably extends radially outward of the cylindrical inner surface 324 of the sidewall 320 of the shell 318 and substantially covers the open end face 329 of the shell 318.

A boot 334 having a first open end 336 and a second open end 338 encases a portion of the bearing 308 and the shell 318 and defines a grease cavity 340 therein. The second open end 338 includes a flange portion 342 disposed between the seal flange 316 of the bearing 308 and the open end face 329 of the shell 318. By sandwiching the flange portion 342 between the seal flange 316 and the end face 329, the second open end 338 may be advantageously retained without the use of a wire spring or clamp. An inner surface of the first end 336 of the boot 334 seals against the shaft portion 304 of the ball stud 302. The first end 336 is secured to the shaft portion 304 by a wire spring or clamp 344 disposed in a groove formed in the outer surface of the boot 334.

Referring now to FIG. 6, a fourth embodiment of the present invention is disclosed. This embodiment is essentially the same as the third embodiment, but incorporates a different way of securing the bearing 308′ to the shell 318′. For this embodiment, elements that remain unchanged from the third embodiment will have the same element numbers, while elements that have changed will have the same element numbers but with an added prime. The bearing 308′ includes a set of teeth 332′ on the outer surface 312′ that extend radially outwardly. The shell 318′ includes a set of corresponding grooves 330′ on its inner surface 324′. The shell 318′ is assembled and secured to the bearing 308′ by sliding the shell 318′ onto the bearing 308′ until the teeth 332′ are fully engaged in the corresponding grooves 330′.

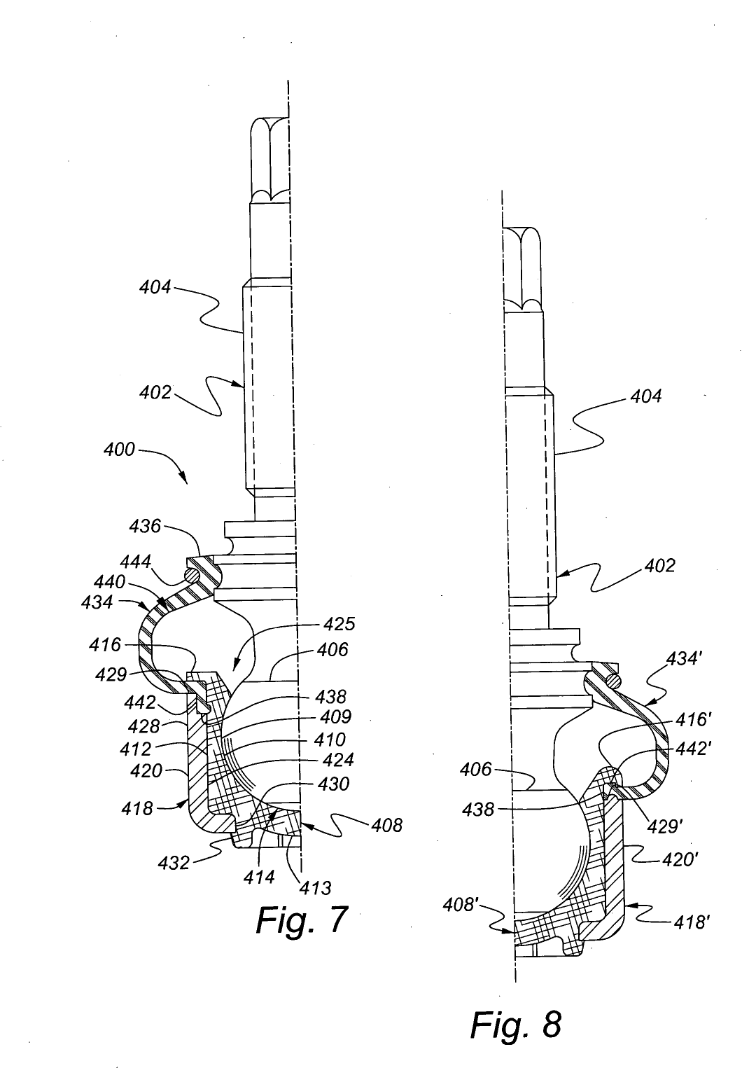

Referring now to FIG. 7, a ball and socket assembly in accordance with a fifth embodiment of the present invention is indicated generally at 400. The assembly 400 includes a ball stud 402 having a shaft portion 404 extending from a ball portion 406.

A bearing 408 includes side wall 409 with an inner surface 410 and an outer surface 412. The bearing 408 includes an enclosed end 413 defining a cavity 414 within which is mounted the ball portion 406. A portion of the side wall 409 includes a radially outwardly extending seal flange 416. Also, a set of barbed flanges 432 extend from the outer surface 412 of the bearing 408. Alternatively, this may be a single barbed flange extending circumferentially around the bearing 408.

A shell 418 includes a sidewall 420 having a generally cylindrical inner surface 424 defining an opening 425 for receiving the bearing 408. The sidewall 420 includes an outer surface 428 and an open end face 429. Also, a set of engagement flanges 430 extend radially inwardly and are spaced and located to mate with the barbed flanges 432 on the bearing 408. The shell 418 is then secured to the bearing 408 by pressing the bearing 408 into the opening 425 of the shell 418 until the barbs 432 on the bearing 408 snap past and become fully engaged with the engagement flanges 430 on the shell 418. The seal flange 416 of the bearing 408 preferably extends radially outward of the cylindrical inner surface 424 of the sidewall 420 of the shell 418 and substantially covers the open end face 429 of the shell 418.

A boot 434 having a first open end 436 and a second open end 438 encases a portion of the bearing 408 and the shell 418 and defines a grease cavity 440. The second open end 438 includes a flange portion 442 extending both radially and axially that is disposed between the seal flange 416 of the bearing 408 and the open end face 429 of the sidewall 420, as well as between the outer surface 412 of the bearing 408 and the inner surface 242 of the shell 418. By sandwiching the flange portion 442 in both the axial and radial direction, the boot 434 may be particularly well retained and provide good sealing without the use of a wire spring or clamp. An inner surface of the first end 436 of the boot 434 seals against the shaft portion 404 of the ball stud 402. The first end 436 is secured to the shaft portion 404 by a wire spring or clamp 444 disposed in a groove formed in the outer surface of the boot 434.

Referring now to FIG. 8, a sixth embodiment of the present invention is disclosed. This embodiment is essentially the same as the fifth embodiment, but with a different arrangement for securing the boot 434′ between the bearing 408′ and the shell 418′. For this embodiment, elements that remain unchanged from the fifth embodiment will have the same element numbers, while elements that have changed will have the same element numbers but with an added prime. The second open end 438′ includes a flange portion 442′ that is only disposed between the seal flange 416′ of the bearing 408′ and the open end face 429′ of the sidewall 420′ of the shell 418′. While this will not provide as much surface area for retention and sealing as the flange portion in the fifth embodiment, the shapes of the mating parts are less complicated, thus possibly simplifying fabrication and assembly.

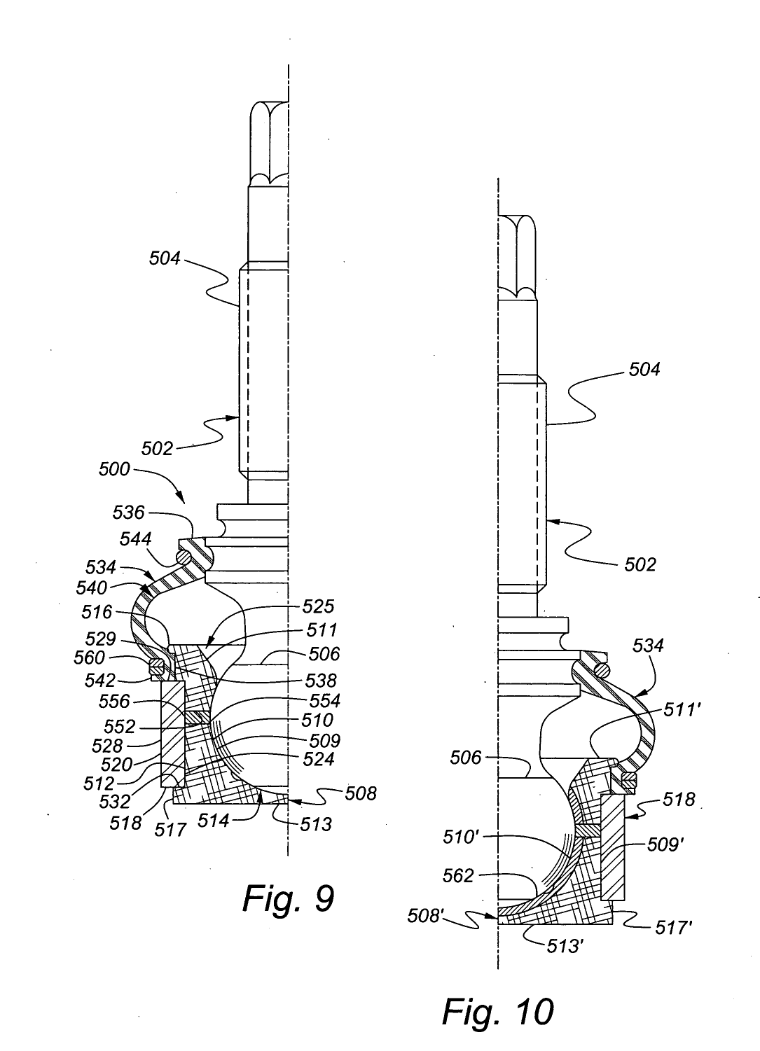

Referring now to FIG. 9, a ball and socket assembly in accordance with seventh embodiment of the present invention is indicated generally at 500. The assembly 500 includes a ball stud 502 having a shaft portion 504 extending from a ball portion 506.

A bearing 508 includes a side wall 509, with an inner surface 510 and an outer surface 512, and end enclosed end 513. The bearing 508 defines a cavity 514 having the ball portion 506 received therein. The bearing 508 is preferably constructed of a plastic material, such as polypropylene, polyvinyl chloride, or the like. The side wall 509 includes a radially outwardly extending seal flange 516. The outer surface 512 preferably includes a radially outwardly extending retention flange 532. The bearing 508 is formed from a first bearing piece 511 and a second bearing piece 517, with the first bearing piece 511 having an attachment face 552, and the second bearing piece 517 having a mating attachment face 554.

A shell 518 includes a sidewall 520 having a generally cylindrical inner surface 524 defining an opening 525 for receiving the bearing 508. The sidewall 520 includes an outer surface 528 and an open end face 529. The shell 518 is preferably constructed of a metal, such as steel, aluminum, or the like. The seal flange 516 of the bearing 508 preferably extends radially outward of the cylindrical inner surface 524 of the sidewall 520 of the shell 518 and substantially covers the open end face 529 of the shell 518.

The bearing 508 and the shell 518 are assembled by sliding the shell 518 around the second bearing piece 517 until the shell abuts the retention flange 532. The ball portion 506 of the ball stud 502 may be inserted into the second bearing piece 517 prior to assembling the shell 518 to the second bearing piece 517. The first bearing piece 511 is slid around the ball stud 502 and within the shell 518 until the attachment face 552 abuts the attachment face 554. A spin-welding operation is then performed to permanently weld the two bearing pieces 511, 517 together, forming an attachment region 556. Alternatively, the bearing pieces 511, 517 are secured together with an adhesive or the like to form the attachment region 556.

A boot 534 having a first open end 536 and a second open end 538 encases a portion of the bearing 508 and the shell 518 and defines a grease cavity 540 therein. The second open end 538 includes a flange portion 542 disposed between the seal flange 516 of the bearing 508 and the open end face 529 of the shell 518. In this embodiment, since the two bearing pieces 511, 517 are preferably spin-welded together, the seal flange 516 has two steps in it. In this way, the flange portion 542 can be retained between the end face 529 and the seal flange 516 even though the boot 534 is assembled to the bearing 508 and shell 518 after the bearing and shell 518 are already assembled to each other. Optionally, a wire spring or clamp 560 may be incorporated to improve the sealing and retention achieved by the flange portion 542 on the second open end 538 of the boot 534. An inner surface of the first open end 536 of the boot 534 seals against the shaft portion 504 of the ball stud 502. The first open end 536 is secure to the shaft portion 504 by a wire spring or clamp 544 disposed in a groove formed in the outer surface of the boot 534.

Referring now to FIG. 10, an eighth embodiment of the present invention is disclosed. This embodiment is essentially the same as the seventh embodiment, but the bearing 508′ includes an insert 562. For this embodiment, elements that remain unchanged from the seventh embodiment will have the same element numbers, elements that have changed will have the same element numbers but with an added prime, while new elements will have new element numbers.

The side wall 509′ and enclosed end 513′ include an insert 562 that forms the inner surface 510′ of the bearing 508′. Preferably, the insert 562 is made of nylon or another material that may have better wear characteristics than the material for the rest of the bearing 508′. The insert 562 may be affixed to the bearing pieces 511′, 517′ by welding, adhesive, insert molding, or the like.

While certain embodiments of the present invention have been described in detail, those familiar with the art to which this invention relates will recognize various alternative designs and embodiments for practicing the invention as defined by the following claims.

1. A ball and socket assembly comprising:
a ball stud having a shaft portion extending from a ball portion;
a bearing having a wall portion defining an open end and an end portion defining a closed end, the wall portion and the end portion further defining a cavity having the ball portion received therein, the open end of the wall portion including a radially outwardly extending seal flange;
a shell having a sidewall portion including a generally cylindrical inner surface for receiving the bearing, the sidewall portion of the shell defining an open end face adjacent to the open end of the bearing, with the seal flange of the bearing extending radially outward of the cylindrical inner surface of the shell and substantially covering the open end face of the shell; and
retention means for securing the shell to the bearing.

2. The assembly of claim 1 further including a boot having a first open end and a second open end enclosing a portion of the bearing and the ball stud and defining a grease cavity therein, with the second open end including a flange portion disposed between the seal flange and the open end face of the sidewall, and with the first end of the boot sealingly engaging the shaft portion of the ball stud.

3. The assembly of claim 1 wherein the retention means includes a dimple in the sidewall portion of the shell extending into the wall portion of the bearing.

4. The assembly of claim 3 wherein the retention means includes a recess in the wall portion of the bearing, and the dimple extends into the recess.

5. The assembly of claim 1 wherein the bearing is formed from a first bearing piece, having a first attachment face, and a second bearing piece, having a second attachment face permanent affixed to the first attachment face, and the retention means includes a radially outwardly extending retention flange in engagement with the sidewall portion of the shell.

6. The assembly of claim 5 wherein the first attachment face is permanently affixed to the second attachment face by welding.

7. The assembly of claim 1 wherein the bearing wall portion is a first bearing piece and the end portion is a second bearing piece formed separate from the first bearing piece, and the retention means includes a barb extending radially inwardly from the first bearing piece and a second barb extending radially outwardly from the second bearing piece and engaging with the barb extending from the first bearing piece.

8. The assembly of claim 1 wherein the retention means includes a barbed flange extending from the end portion of the bearing and an engagement flange extending from the shell and in engagement with the barbed flange.

9. The assembly of claim 1 wherein the retention means includes a plurality of teeth formed in the wall portion of the bearing and a second plurality of teeth formed in the sidewall portion of the shell and engaged with the plurality of teeth in the bearing.

10. The assembly of claim 1 wherein the retention means includes a plurality of teeth formed in a one of the wall portion of the bearing and the sidewall portion of the shell and a plurality of grooves in an other of the wall portion of the bearing and the sidewall portion of the shell, and with the plurality of teeth engaged with the plurality of grooves.

11. The assembly of claim 1 wherein the open end face of the shell includes a radially outwardly extending flange adjacent to the seal flange of the bearing and adapted for receiving a flange portion of a boot between the seal flange and the radially outwardly extending flange.

12. The assembly of claim 1 wherein the shell further includes a closed end portion connected to the sidewall portion and adjacent to the end portion of the bearing.

13. A ball and socket assembly comprising:
a ball stud having a shaft portion extending from a ball portion;
a bearing having a wall portion defining an open end and an end portion defining a closed end, the wall portion and the end portion further defining a cavity having the ball portion received therein; and
a shell having a sidewall portion including a generally cylindrical inner surface for receiving the bearing, with a dimple in the sidewall portion of the shell extending into the wall portion of the bearing to thereby secure the shell to the bearing.

14. The assembly of claim 13 wherein the wall portion of the bearing includes a recess, and the dimple extends into the recess.

15. The assembly of claim 13 further including at least a second dimple in the sidewall portion of the shell extending into the wall portion of the bearing.

16. The assembly of claim 13 wherein the sidewall portion of the shell defines an open end face, and the open end defined by the wall portion of the bearing includes a radially outwardly extending seal flange extending radially outward of the cylindrical inner surface of the shell and substantially covering the open end face of the shell.

17. The assembly of claim 16 further including a boot having a first open end and a second open end enclosing a portion of the bearing and the ball stud and defining a grease cavity therein, with the second open end including a flange portion disposed between the seal flange and the open end face of the sidewall.

18. A ball and socket assembly comprising:
a ball stud having a shaft portion extending from a ball portion;
a bearing formed from a first bearing piece, having a first attachment face, and a second bearing piece, having a second attachment face permanent affixed to the first attachment face, with the bearing having a wall portion defining an open end and an end portion defining a closed end, the wall portion and the end portion further defining a cavity having the ball portion received therein, and with the bearing having a radially outwardly extending retention flange; and
a shell having a sidewall portion including a generally cylindrical inner surface for receiving the bearing, and with the sidewall portion in engagement with the retention flange.

19. The assembly of claim 18 wherein the first attachment face is permanently affixed to the second attachment face by spin welding.

20. The assembly of claim 18 wherein the first attachment face is permanently affixed to the second attachment face by an adhesive.

21. The assembly of claim 18 wherein the sidewall portion of the shell defines an open end face, and the open end defined by the wall portion of the bearing includes a radially outwardly extending seal range extending radially outward of the cylindrical inner surface of the shell and substantially covering the open end face of the shell.

22. The assembly of claim 18 further including a boot having a first open end and a second open end enclosing a portion of the bearing and the ball stud and defining a grease cavity therein, with the second open end including a flange portion disposed between the seal flange and the open end face of the sidewall.

23. The assembly of claim 18 wherein the first bearing piece and the second bearing piece each include an insert, with the inserts forming an inner surface of the bearing that is in contact with the ball portion of the ball stud.

24. A ball and socket assembly comprising:
a ball stud having a shaft portion extending from a ball portion;
a bearing having a first bearing piece forming a wall portion including a first open end, a second open end and a barb extending radially inwardly adjacent to the second open end, and a second bearing piece forming an end portion including a retention surface and a second barb extending radially outwardly and engaging with the barb extending from the first bearing piece to secure the second bearing piece to the first bearing piece, and with the first bearing piece and the second bearing piece defining a cavity having the ball portion received therein; and
a shell having a sidewall including a generally cylindrical inner surface for receiving the first bearing piece and a retention open end face engaged with the retention surface of the second bearing piece.

25. The assembly of claim 24 wherein the sidewall portion of the shell defines an open end face, and the first open end of the wall portion includes a radially outwardly extending seal flange extending radially outward of the cylindrical inner surface of the shell and substantially covering the open end face of the shell.

26. The assembly of claim 24 further including a boot having a first open end and a second open end enclosing a portion of the bearing and the ball stud and defining a grease cavity therein, with the second open end including a flange portion disposed between the seal flange and the open end face of the sidewall.

27. A ball and socket assembly comprising:
a ball stud having a shaft portion extending from a ball portion;
a bearing having a wall portion defining an open end and an end portion defining a closed end, the wall portion and the end portion further defining a cavity having the ball portion received therein, and with the bearing including a barbed flange extending from the end portion; and
a shell having a sidewall portion including a generally cylindrical inner surface for receiving the bearing and an engagement flange extending from the shell and in engagement with the barbed flange to thereby secure the shell to the bearing.

28. The assembly of claim 27 wherein the sidewall portion of the shell defines an open end face, and the open end of the wall portion of the bearing includes a radially outwardly extending seal flange extending radially outward of the cylindrical inner surface of the shell and substantially covering the open end face of the shell.

29. The assembly of claim 28 further including a boot having a first open end and a second open end enclosing a portion of the bearing and the ball stud and defining a grease cavity therein, with the second open end including a flange portion disposed between the seal flange and the open end face of the sidewall.

30. A ball and socket assembly comprising:
a ball stud having a shaft portion extending from a ball portion;
a bearing having a wall portion defining an open end and an end portion defining a closed end, with the wall portion and the end portion further defining a cavity having the ball portion received therein, and the wall portion including an engagement mechanism; and
a shell having a sidewall portion including a generally cylindrical inner surface for receiving the bearing and a second engagement mechanism on the inner surface of the sidewall portion and in engagement with the engagement mechanism of the bearing to thereby secure the shell to the bearing, and with a one of the engagement mechanism and the second engagement mechanism being a plurality of teeth.

31. The assembly of claim 30 wherein an other of the engagement mechanism and the second engagement mechanism is a plurality of corresponding grooves in engagement with the plurality of teeth.

32. The assembly of claim 30 wherein an other of the engagement mechanism and the second engagement mechanism is a second plurality of corresponding teeth in engagement with the plurality of teeth.

33. The assembly of claim 30 wherein the sidewall portion of the shell defines an open end face, and the open end of the wall portion of the bearing includes a radially outwardly extending seal flange extending radially outward of the cylindrical inner surface of the shell and substantially covering the open end face of the shell.

34. The assembly of claim 33 further including a boot having a first open end and a second open end enclosing a portion of the bearing and the ball stud and defining a grease cavity therein, with the second open end including a flange portion disposed between the seal flange and the open end face of the sidewall.
